(19) United States
(12) Patent Application Publication
(10) Pub. No.: US 2021/0043407 A1
(43) Pub. Date: Feb. 11, 2021

(54) FUSE FOR A 48V BATTERY SYSTEM OF AN ELECTRIC VEHICLE

(71) Applicant: COOPER XI'AN FUSEGEAR CO., LTD., XI AN (CN)

(72) Inventors: HUASHENG WANG, XI AN (CN); SHUFANG ZHANG, XI AN (CN); XUFENG WANG, XI AN (CN)

(21) Appl. No.: 16/988,150

(22) Filed: Aug. 7, 2020

(30) Foreign Application Priority Data
Aug. 9, 2019 (CN) 201921287653.7

(51) Int. Cl. H01H 85/08; H01H 85/02

(52) U.S. Cl. CPC H01H 85/08; H01H 2085/025; H01H 85/0241

(57) ABSTRACT

The present disclosure provides a fuse for protecting a 48V battery system of an electric vehicle, which includes a shell and a fuse element arranged in the shell, wherein the fuse element includes a fusing portion, and a first heating portion and a second heating portion which are connected to two sides of the fusing portion, respectively and the fusing portion has a width greater than that of the first heating portion and the second heating portion, the fusing portion includes at least one hole which partitions the fusing portion into constricted portions each having a width less than that of the first heating portion or the second heating portion, and the fusing portion, the first heating portion and the second heating portion are formed integrally.

### CROSS REFERENCE TO RELATED APPLICATIONS

This patent application claims the benefit and priority of Chinese Patent Application No. 201921287653.7 filed on Aug. 9, 2019, the disclosure of which is incorporated by reference herein in its entirety as part of the present application.

### BACKGROUND

The present disclosure relates to the field of fuses, and in particular relates to a fuse for protecting a 48V battery system of an electric vehicle.

With the gradual exhaustion of petroleum resources and the increasing severity of environmental pollution, new energy vehicles, especially electric vehicles, have attracted more and more attention. A 48V battery system is a mainstream battery system in the field of electric vehicles. The 48V battery system means that the system has a voltage of 48 V, a conventional lead-acid battery is replaced with a power lithium-ion battery having energy less than one kilowatt-hour of electricity and a conventional start motor and a generator are replaced with a BSG motor. In addition to the automatic start/stop function, the 48V battery system can also provide a vehicle with auxiliary power if necessary.

For a battery system, the safety and service life of the battery are very important. As one kind of short-circuit and overcurrent protectors, fuses have become the focus of battery system research. Compared with conventional fuses for protection, the fuses for protecting 48V battery systems are more highly required: small size, high requirement on temperature rising, strict requirement on fusing time for small overload, and strong breaking capacity. In addition, it is required that the fuses do not fail after severe environmental tests (e.g., high-/low-temperature shock, mechanical shock vibration, and chemical corrosion).

### BRIEF DESCRIPTION

Hence, to overcome the deficiencies in the prior art, the present disclosure provides a fuse for protecting a 48V battery system of an electric vehicle, including a shell and a fuse element arranged in the shell, wherein the fuse element includes a fusing portion, and a first heating portion and a second heating portion which are connected to two sides of the fusing portion, respectively, and the fusing portion has a width greater than that of the first heating portion and the second heating portion, the fusing portion includes at least one hole which partitions the fusing portion into constricted portions each having a width less than that of the first heating portion or the second heating portion, and, the fusing portion, the first heating portion and the second heating portion are formed integrally.

In accordance with the fuse provided by the present disclosure, the at least one hole may be a square hole.

In accordance with the fuse provided by the present disclosure, the fusing portion may include two holes.

In accordance with the fuse provided by the present disclosure, the constricted portions may each have a width of about 0.5 mm to 1.7 mm.

In accordance with the fuse provided by the present disclosure, the constricted portions may each have a thickness of about 0.5 mm.

In accordance with the fuse provided by the present disclosure, the fuse further may include a first terminal connected to the first heating portion and a second terminal connected to the second heating portion.

In accordance with the fuse provided by the present disclosure, mounting holes may be formed in the first terminal and the second terminal, respectively.

In accordance with the fuse provided by the present disclosure, guide columns fitted into the mounting holes may be arranged in the shell.

In accordance with the fuse provided by the present disclosure, the shell may include an upper shell and a lower shell, and the guide columns may be formed on the lower shell.

In accordance with the fuse provided by the present disclosure, the upper shell and the lower shell are sealed with each other.

Compared with the prior art, the fuse provided by the present disclosure is small in size, good in temperature rising performance and high in breaking capacity, and can be free of failure in a harsh environment.

### BRIEF DESCRIPTION OF THE DRAWINGS

The embodiments of the present disclosure will be further described below with reference to the accompanying drawings, in which:

FIG. 1 is a longitudinally sectional view of the fuse according to an embodiment of the present disclosure;

FIG. 2 is a top sectional view of the fuse according to an embodiment of the present disclosure;

FIG. 3 is a perspective view of the fuse according to an embodiment of the present disclosure; and

FIG. 4 is a perspective sectional view of the fuse according to an embodiment of the present disclosure.

### DETAILED DESCRIPTION

To make the technical solutions and advantages of the present disclosure clearer, the present disclosure will be further described below in detail by specific embodiments with reference to the accompanying drawings. It should be understood that the specific embodiments described herein are merely used for explaining the present disclosure, rather than limiting the present disclosure.

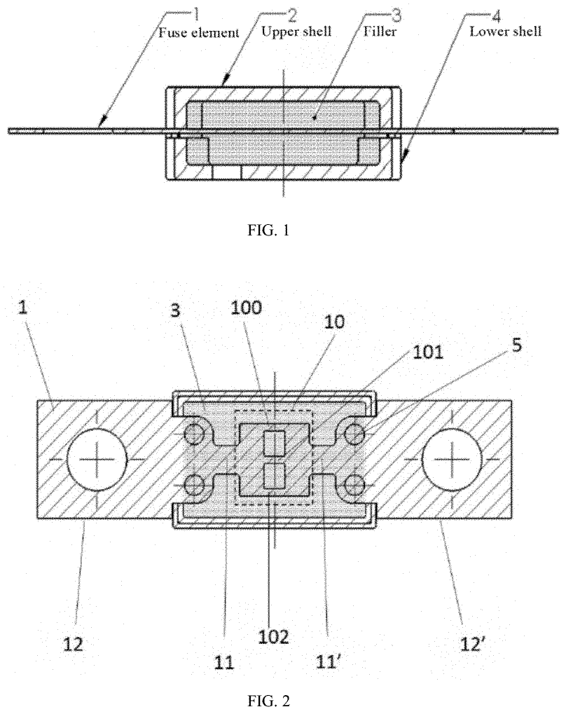

FIGS. 1-3 show a longitudinally sectional view, a top sectional view and a perspective view of a fuse according to an embodiment of the present disclosure, where like reference numerals represent like components. The fuse provided by the present disclosure includes an upper shell 2, a lower shell 4, and a fuse element 1 arranged between the upper shell 2 and the lower shell 4. A filler 3 (e.g., sand) is further arranged in both the upper shell 2 and the lower shell 4. FIG. 2 shows the structure of the fuse element 1 of the fuse according to the present disclosure. The fuse element 1 includes a fusing portion 10 in the middle, a first heating portion 11 and a second heating portion 11′ which are connected to the fusing portion 10, respectively, and a first terminal 12 and a second terminal 12′ which are connected to the first heating portion 11 and the second heating portion 11′, respectively. The fusing portion 10 has a width greater than that of the heating portions 11 and 11′. The fusing portion 10 includes two square holes. The two square holes partition the fusing portion 10 into three constricted portions 100, 101, and 102. The three constricted portions 100, 101, and 102 each have a width less than that of the heating portions 11 and 11′. When a large current passes through the fuse element 1, the constricted portions 100, 101, and 102 are disconnected to realize protection. In addition, two mounting holes 5 are formed in the first terminal 12 and the second terminal 12′, respectively. FIG. 4 shows a perspective sectional view of the fuse according to the present disclosure, where a portion of the upper shell 2 is removed to expose a portion of the fuse element 1 in the shell. It can be seen that guide columns 6 are further arranged in an inner side of the lower shell 4. When the fuse element 1 is assembled in the shell, the guide columns 6 are inserted into the mounting holes 5 formed in the fuse element 1, so that the fuse element 1 is fixed accurately and firmly. In addition, in the present disclosure, the fusing portion and the heating portions of the fuse element are formed integrally, and the upper shell 2 and the lower shell 4 are sealed by ultrasonic welding using a welding wire.

To reflect the advantages of the fuse provided by the present disclosure, the inventor(s) has (have) conducted a mechanical shock vibration test on the fuse.

The fuse is subjected to shock by half sine wave of 6 ms at an acceleration of 50 g in shock directions ±X, ±Y and ±Z each for 10 times (60 times in total), and then vibrated in X, Y and Z planes each for 8 hours. During this process, the temperature changes from −40° C. to 125° C., see table 1 below:

TABLE 1

| Time Min | Temperature ° C. |
|---|---|
| 0 | 20 |
| 60 | −40 |
| 150 | −40 |
| 210 | 20 |
| 300 | 125 |
| 410 | 125 |
| 480 | 20 |

Vibration parameters include the root mean square of acceleration, and the power spectral density is relatively harsh, see table 2.

TABLE 2

| Parameter | | |
|---|---|---|
| Minimum temperature value | −40° | C. |
| Maximum temperature value | 125° | C. |
| Root mean square of acceleration | 30.8 | m/s2 |

Vibration description

| Frequency Hz | Power spectral density (m/s2)2/Hz |
|---|---|
| 5 | 0.884 |
| 10 | 20 |
| 55 | 6.5 |
| 180 | 0.25 |
| 300 | 0.25 |
| 360 | 0.14 |
| 1000 | 0.14 |
| 2000 | 0.14 |

It can be seen that the fuse provided by the present disclosure is still good in temperature rising performance under harsh test conditions.

For the constricted portions, the inventor(s) has (have) conducted theoretical calculation and experimental verification, and has (have) given the design parameters shown in table 3, where the current rating has a unit of A, the width and thickness of the constricted portions have a unit of mm, the section area is the total section area of the constricted portions (i.e., the width of the constricted portions×the thickness of the constricted portions×the number of constricted portions), with a unit of mm² and the current density is the ratio of the current to the section area, with a unit of A/mm². The current density affects the electrical performance and temperature rising power consumption of the fuse, and becomes a key for the design of the present disclosure. In the situations shown in the table, the fuse element (particularly fusing portions) is differently designed for different current ratings. In these situations, good electrical performance and temperature rising power consumption can be achieved.

TABLE 3

| | Width of | The number | | | | |
|---|---|---|---|---|---|---|
| Cur- | the con- | of con- | | The number | Sec- | Cur- |
| rent | stricted | stricted | Thick- | of fuse | tion | rent |
| rating | portion | portions | ness | elements | area | density |
| 150 | 0.4 | 2 | 0.5 | 1 | 0.4 | 375.0 |
| 175 | 0.5 | 2 | 0.5 | 1 | 0.5 | 350.0 |
| 200 | 0.6 | 2 | 0.5 | 1 | 0.6 | 333.3 |
| 200 | 0.7 | 2 | 0.5 | 1 | 0.7 | 285.7 |
| 225 | 0.5 | 3 | 0.5 | 1 | 0.75 | 300 |
| 250 | 0.75 | 3 | 0.5 | 1 | 1.125 | 222 |
| 300 | 1.2 | 3 | 0.5 | 1 | 1.8 | 166.7 |
| 350 | 1.7 | 3 | 0.5 | 1 | 2.55 | 137.3 |
| 400 | 0.85 | 2 | 1 | 1 | 1.7 | 235.3 |
| 450 | 1 | 2 | 1 | 1 | 2 | 225.0 |
| 500 | 1 | 3 | 1 | 1 | 3 | 166.7 |

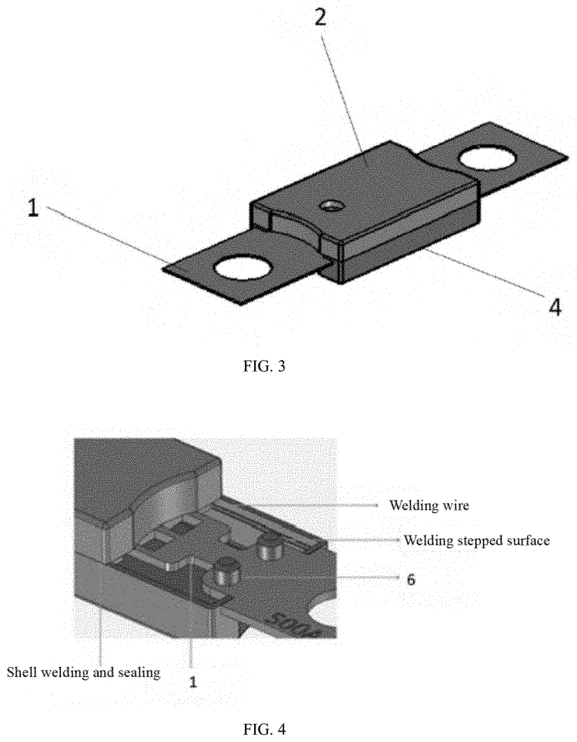

It can be seen from this table that, in addition to the design of three constricted portions shown in FIG. 3, two constricted portions are also selectable.

In accordance with other embodiments of the present disclosure, for the fusing portion, the constricted portions may be realized by holes in other shapes known in the art, such as round holes or oval holes.

In accordance with other embodiments of the present disclosure, the upper shell and the lower shell are sealed by other sealing methods known in the art.

The fuse provided by the present disclosure is small in size, good in temperature rising performance and strong in breaking capacity, and can be free of failure in a harsh environment.

Although the present disclosure has been described by the example embodiments, the present disclosure is not limited to the embodiments described herein. Various alterations and variations made without departing from the scope of the present disclosure shall be included.

1. A fuse for protecting a 48V battery system of an electric vehicle, comprising a shell and a fuse element arranged in the shell, wherein the fuse element comprises a fusing portion, and a first heating portion and a second heating portion which are connected to two sides of the fusing portion, respectively, and the fusing portion has a width greater than that of the first heating portion and the second heating portion, wherein the fusing portion comprises at least one hole which partitions the fusing portion into constricted portions each having a width less than that of the first heating portion or the second heating portion, and wherein the fusing portion, the first heating portion and the second heating portion are formed integrally.

2. The fuse according to claim 1, wherein the at least one hole is a square hole.

3. The fuse according to claim 1, wherein the fusing portion comprises two holes.

4. The fuse according to claim 3, wherein the constricted portions each have a width of 0.5 mm to 1.7 mm.

5. The fuse according to claim 4, wherein the constricted portions each have a thickness of 0.5 mm.

6. The fuse according to claim 1, further comprising a first terminal connected to the first heating portion and a second terminal connected to the second heating portion.

7. The fuse according to claim 6, wherein mounting holes are formed in the first terminal and the second terminal, respectively.

8. The fuse according to claim 7, wherein guide columns fitted into the mounting holes are arranged in the shell.

9. The fuse according to claim 8, wherein the shell comprises an upper shell and a lower shell, and wherein the guide columns are formed on the lower shell.

10. The fuse according to claim 9, wherein the upper shell and the lower shell are sealed with each other.
